(19) United States
(12) Patent Application Publication
(10) Pub. No.: US 2025/0379663 A1
(43) Pub. Date: Dec. 11, 2025

(54) COMMUNICATION SYSTEM FOR DATA TRANSFER USING HUMAN BODY RESONANCE

(71) Applicant: Quasistatics Inc., West Lafayette, IN (US)

(72) Inventors: Shreyas Sen, West Lafayette, IN (US); Samyadip Sarkar, West Lafayette, IN (US)

(21) Appl. No.: 18/738,328

(22) Filed: Jun. 10, 2024

(51) Int. Cl. H04B 13/00

(52) U.S. Cl. CPC H04B 13/005

(57) ABSTRACT

Embodiments of the present disclosure relate generally to the field of communication between communicating devices and more particularly relates to a communication system for data transfer using human body communication. The communication system includes, a first communicating device to excite a conducting medium by transmitting electromagnetic (EM) signals to a surface of the conducting medium to generate a transmitter side resonance. Further, the communication system includes the conducting medium communicatively coupled to the first communication device via a body communication network. The conducting medium is configured to establish the broadband communication channel between the first communicating device and a second communicating device. Furthermore, the second communicating device comprising a receiver configured to receive the data as the EM signals transmitted from the first communicating device via the surface of the conducting medium.

### FIELD OF INVENTION

The present disclosure generally relates to the field of communication between communicating devices, more particularly relates to a communication system for data transfer using human body resonance.

### BACKGROUND

A human body, like any other medium of communication, may be used as a medium for communication. In a Human Body Communication (HBC), the human body is utilized as a communication medium between devices on and around the human body. The Human Body Communication (HBC) requires a small amount of an Electromagnetic (EM) signal to be sent through the human body to allow the devices on and around the human body to communicate without any wired and wireless connections.

Conventionally, the Human Body Communication (HBC) is being used in transferring the information between devices connected on and around the human body. Unlike conventional wireless communication that relies on electromagnetic waves radiating outwards such as Radio Frequency (RF) communication and the like, Electro-Quasistatic Human Body Communication (EQS-HBC) is configured to leverages the body's tissues and fluids as a conductor to confine the signal within the human body. Transfer of data, such as authentication, image sharing, audio files sharing, gaming, sharing localisation information is performed using various techniques such as Electro-Quasistatic Human Body Communication (ESQ-HBC) or the like. However, the EQS-HBC is bound to limitations such as, higher channel loss of 60-70 dB approximately while transferring data, limited channel capacity resulted from high channel loss of 60-70 dB limitation on carrier frequency to around 20 MHz, it cannot support applications requiring hundreds of Mbps data. This high channel loss and not-so-wide bandwidth (1 kHz to 1 MHz and 1 MHz to even 20 MHz) imposes severe constraint on the emergence of high data rate body-centric applications. The transfer of data in conventional methods of Human Body Communication (HBC) is performed over a low bandwidth lower data transfer rates such as, in bps, kbps, mbps, tens of mbps or the like, and limitation of carrier frequency to be around 20 MHz prevents the existing Human Body Communication system from using high data rate applications such as, Human Body Communication-based AR/VR headsets, browsing social networking platforms, online gaming, and high-quality video streaming using battery-powered communicating devices.

Consequentially, with increasing number of body wearable communication devices, the Human Body communication (HBC) with existing methods of communication does not support high data transfer rate. Furthermore, the existing HBC also has a lower bandwidth of a communication channel, a lower channel gain, and a limitation on a carrier frequency.

Therefore, there is need for more robust and reliable Human Body Communication (HBC) system to address the aforementioned issues.

### SUMMARY

In accordance with an embodiment of the present disclosure, a communication system for data transfer using human body resonance is disclosed. The system may include:
a first communicating device including a transmitter. The transmitter is configured to excite a conducting medium by transmitting electromagnetic (EM) signals to a surface of the conducting medium to generate a transmitter side resonance. The transmitter side resonance includes a transmitter side resonance frequency.

Further, the transmitter is further configured to generate resonant EM wave patterns on the conducting medium to establish a broadband communication channel with the conducting medium based on the generated transmitter side resonance.

Furthermore, the communication system includes a conducting medium communicatively coupled to the first communication device via a body communication network. The conducting medium is configured to exhibit resonance at a body resonance frequency based on the generated resonant EM wave patterns. Further, the conducting medium is configured to establish the broadband communication channel with the first communicating device based on the body resonance frequency. Furthermore, the conducting medium is configured to transfer data as the EM signals from the first communicating device to a second communicating device.

Furthermore, the communication system further includes the second communicating device communicatively coupled to the first communicating device via the conducting medium. The second communicating device includes a receiver.

The receiver is configured to generate a receiver side resonance frequency corresponding to the transmitter side resonance frequency and the body resonance frequency using a high impedance termination circuit.

The receiver further is configured to activate a resonant body resonance (BR) human body communication (HBC) mode corresponding to the transmitter side resonance frequency and a peak frequency of body resonance using the high impedance termination circuit. Furthermore, the receiver is configured to receive the data as the EM signals transmitted from the first communicating device via the surface of the conducting medium.

In accordance with another embodiment of the present disclosure, a method for data transfer using human body resonance is disclosed. The method includes, exciting, by a first communicating device including a transmitter, a conducting medium by transmitting electromagnetic (EM) signals to a surface of the conducting medium to generate a transmitter side resonance. The transmitter side resonance includes a transmitter side resonance frequency.

Further, the method for data transfer using human body resonance includes generating, by the first communicating device including the transmitter, resonant EM wave patterns on the conducting medium to establish a broadband communication channel with the conducting medium based on the generated transmitter side resonance.

Further, the method for data transfer using human body resonance includes exhibiting, by the conducting medium, a resonance at a body resonance frequency based on the generated resonant EM wave patterns.

Further, the method for data transfer using human body resonance includes establishing, by the conducting medium, the broadband communication channel with the first communicating device based on the body resonance frequency.

Further, the method for data transfer using human body resonance includes transferring, by the conducting medium, data as the EM signals from the first communicating device to a second communicating device.

Further, the method for data transfer using human body resonance includes generating, by the second communicating device including a receiver, the receiver side resonance frequency corresponding to the transmitter side resonance frequency and the body resonance frequency using a high impedance termination circuit.

Further, the method includes activating, by the second communicating device including a receiver, a resonant body resonance (BR) human body communication (HBC) mode corresponding to the transmitter side resonance frequency and a peak frequency of body resonance using the high impedance termination circuit.

Furthermore, the method includes receiving, by the second communicating device including a receiver, the data as the EM signals transmitted from the first communicating device via the surface of the conducting medium.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1A illustrates a block diagram representation of an exemplary communication system for data transfer using human body resonance, in accordance with an embodiment of the present disclosure;

FIG. 1B illustrates a block diagram representation of an exemplary communication system for data transfer using human body resonance, in accordance with another embodiment of the present disclosure;

FIG. 2 illustrates a block diagram representation of an exemplary communicating device for communication using a human body resonance, in accordance with an embodiment of the present disclosure;

FIG. 3 illustrates an EM field intensity map representation comparison between a conventional Electro-Quasistatic (EQS) HBC and a Body Resonance (BR) HBC, in accordance with an embodiment of the present disclosure;

FIG. 4 illustrates an exemplary schematic diagram representation of a communication system circuitry and a design of surface feed communicating devices in a Body Resonance (BR) HBC, in an accordance with an embodiment of the present disclosure;

FIG. 5 illustrates an exemplary schematic diagram representation of comparison of channel gain between an Electro-Quasistatic (EQS) HBC and a Body Resonance (BR) HBC with plurality of termination impedances at a receiver end, in accordance with an embodiment of the present disclosure;

FIG. 6 illustrates an exemplary schematic diagram representation of circuitry of Human Body Resonance, in accordance with an embodiment of the present disclosure;

FIG. 7 illustrates an exemplary schematic diagram representation of communicating devices at a transmitting end and a receiving end of Human Body Communication, in an accordance with an embodiment of the present disclosure;

FIG. 8 illustrates an exemplary schematic diagram representation of a channel capacity optimization through resonance in Human Body resonance, in accordance with an embodiment of the present disclosure;

FIG. 9 illustrates an exemplary graphical representation of a receiver resistance variation for obtaining a suitable channel gain in e Human Body resonance, in an accordance with an embodiment of the present disclosure;

FIG. 10 illustrates an exemplary graphical representation of a source (i.e. transmitter) resistance variation for obtaining suitable channel gain in Human Body Resonance, in an accordance with an embodiment of the present disclosure;

FIG. 11 illustrates an exemplary graphical diagram representation of an adaptability of resonant mode with changes in the location of the devices and the subject's posture via suited adjustment of system parameters, in accordance with an embodiment of the present disclosure;

FIG. 12 illustrates an exemplary schematic diagram representation of power transfer between a first communication device and a second communication device, in accordance with an embodiment of the present disclosure;

FIG. 13 illustrates an exemplary graphical diagram representation of implementation of power transfer via a resonant mode of powering from a wearable transmitter to a wearable receiver, in accordance with an embodiment of the present disclosure; and

FIG. 14 illustrates an exemplary process flow diagram representation depicting a process of data transfer using human body resonance, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

Embodiments of the present disclosure provides a communication system for data transfer using human body communication resonance.

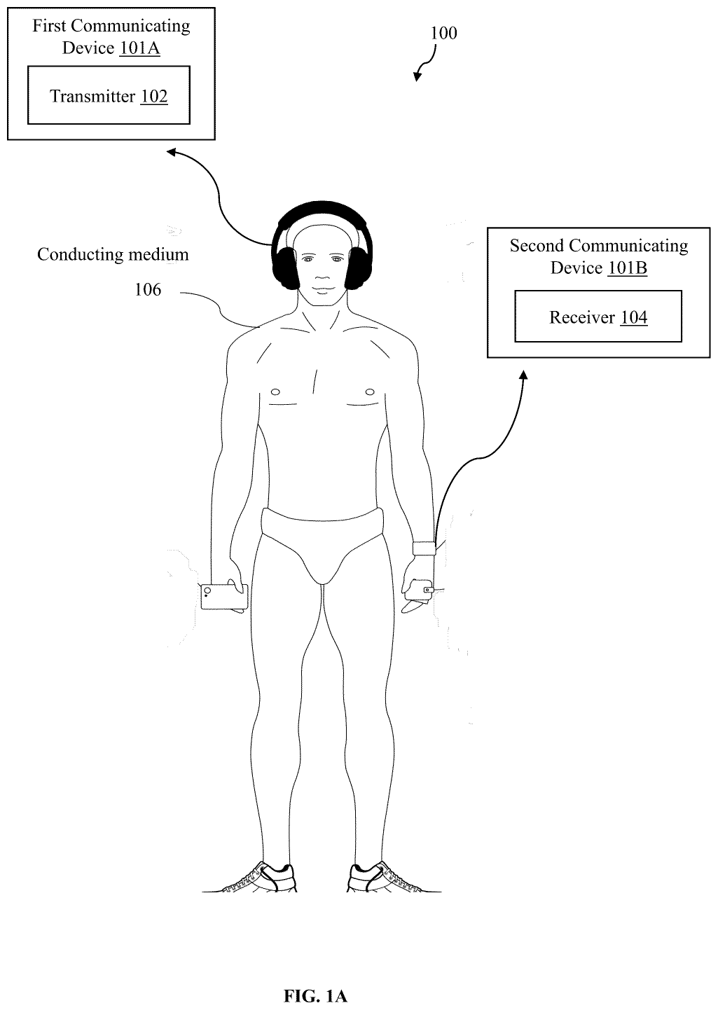

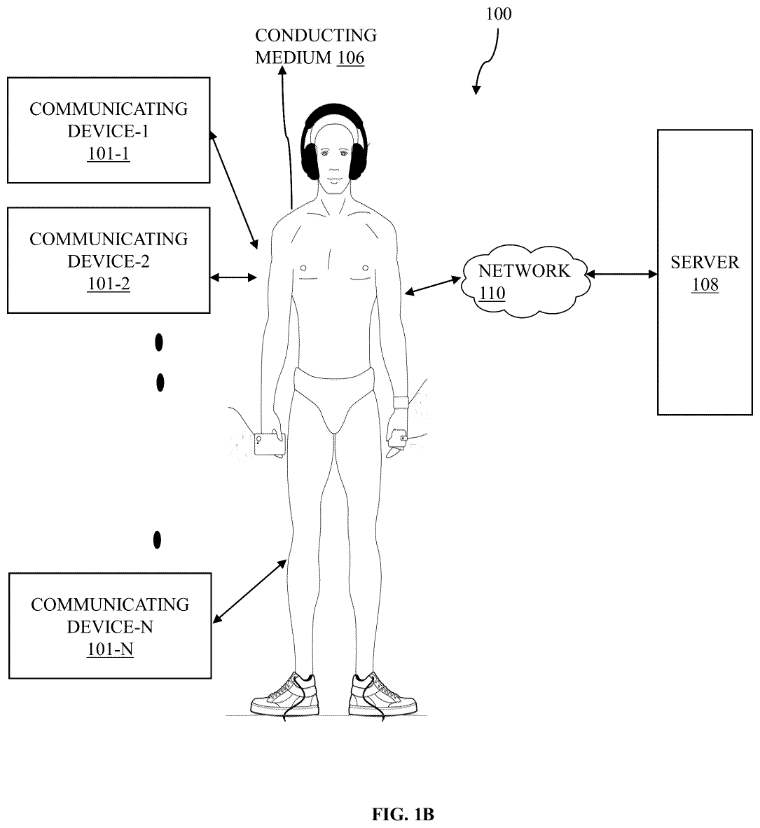

Referring now to the drawings, and more particularly to FIG. 1A through FIG. 14, where similar reference characters denote corresponding features consistently throughout the figures, there are shown preferred embodiments and these embodiments are described in the context of the following exemplary system and/or method.

FIG. 1A illustrates a block diagram representation of an exemplary communication system 100 for data transfer using human body resonance, in accordance with an embodiment of the present disclosure. The communication system 100 includes, a first communicating device 101A. The first communicating device 101A includes a transmitter 102. Further, the transmitter 102 may be configured to excite a conducting medium 106 by transmitting electromagnetic (EM) signals to a surface of the conducting medium 106 to generate a transmitter side 102 resonance. The transmitter side 102 resonance includes a transmitter side resonance frequency. Further, the transmitter 102 includes a series-connected inductor (L_{Tx}) connected in series with a source resistor (Rs) for adjusting the transmitter side 102 resonance frequency with the peak frequency of body resonance. Further, the transmitter 102 is excited with an alternating current (AC) voltage source of a defined amplitude value and a defined source resistance value (R_{Tx}).

Further, the communication system 100 includes, the conducting medium 106 communicatively coupled to the first communication device 101A via a body communication network. The conducting medium 106 may be configured to exhibit resonance at a body resonance frequency based on the generated resonant EM wave patterns. Further, the conducting medium 106 may be configured to establish the broadband communication channel with the first communicating device 101A based on the body resonance frequency. Furthermore, the conducting medium 106 may be configured to transfer data as the EM signals from the first communicating device 101A to a second communicating device 101B.

Furthermore, the communication system 100 includes the second communicating device 101B communicatively coupled to the first communicating device 101A via the conducting medium 106. The second communicating device 101B includes a receiver 104 configured to generate a receiver side 104 resonance frequency corresponding to the transmitter side 102 resonance frequency and the body resonance frequency using a high impedance termination circuit. The high impedance termination circuit includes a parallel inductor connected in parallel to a load. Further, the parallel inductor may be configured to perform optimum impedance termination by adjusting a resistive and a reactive component of the parallel inductor, and the parallel inductor may be configured to emulate a parallel resonance. Further, the receiver 104 may be configured to activate a resonant body resonance (BR) human body communication (HBC) mode corresponding to the transmitter side 102 resonance frequency and a peak frequency of body resonance using the high impedance termination circuit. The resonant body resonance (BR) human body communication (HBC) mode may be activated by synchronizing the transmitter side resonance frequency with the determined peak frequency of the body resonance and the receiver side resonance frequency. Furthermore, in an embodiment, the receiver 104 is configured receive the data as the EM signals transmitted from the first communicating device 101A via the surface of the conducting medium 106.

The first communicating device 101A and the second communicative device 101B may be, but not limited to, a headphone, a smart-watch, a wrist-band, a smart eyewear, any other wearable devices, or the like. The conducing medium 106 may be, but not limited to, the human body, a cross-cylindrical human body model, parallel plates and the like.

Those of ordinary skilled in the art will appreciate that the hardware depicted in FIG. 1 may vary for particular implementations. For example, the communication device 101A and 101B may include, such as for example, but not limited to, smart-watch, smart wristband, smart eye-wear, earbuds, headphones, waist-band and the like. The depicted example is provided for the purpose of explanation only and is not meant to imply architectural limitations with respect to the present disclosure.

FIG. 1B illustrates a block diagram representation of an exemplary communication system 100 for data transfer using human body resonance, in accordance with another embodiment of the present disclosure. The communication system 100 includes multiple communicating devices 101-1, . . . , 101-N configured to transmit and receive a data via a conducting medium 106. The multiple communicating devices 101-1, . . . , 101-N may include a transmitter 102, coupled to the conducting medium 106 via Human Body Communication (HBC).

Furthermore, the conducting medium 106 is coupled to a network 110. The network 110 may include, but not limited to, Wireless Personal Area Network (WPLAN), Wireless Local Area Network (W LAN), Wireless Metropolitan Area Network, Wireless Wide Area Network and the like. The network 110 may be configured to works as the infrastructure that allows multiple communicating devices 101-1, . . . , 101-N to connect and exchange information with a server 108. The network 110 establishes a connection between multiple communicating devices 101-1, . . . , 101-N, and the server 108, enabling the communicating devices 101-1, . . . , 101-N to communicate regardless of their physical location. The server 108 may be configured to function as an intermediary, facilitating the seamless flow of data between the multiple communicating devices 101-1, . . . , 101-N. Further, the server 108 (also referred herein as computing device 108) may include a processor (not shown) and a memory (not shown) coupled to the processor (not shown). The memory (not shown) includes processor (not shown)-executable instructions, which on execution, cause the processor (not shown) to determine a location of a peak frequency and a notch in a channel transfer characteristic. Further, the processor (not shown) is configured to adjust the determined location of the peak frequency and the notch based on required energy efficiency and data transfer rate requirements. Further, the processor (not shown) is configured to synchronize the transmitter side resonance frequency with the determined peak frequency of the body resonance and the receiver side resonance frequency by tuning the series-connected inductor (LTx) (not shown) of the transmitter 102 and the parallel inductor of the receiver 104.

Further, the processor (not shown) is configured to generate an optimized operational bandwidth, a peak channel gain and a quality factor for data transfer between the first communicating device and the second communicating device based on the synchronization. Furthermore, the processor (not shown) is configured to position the first communicating device 101A and the second communicating device 101B to optimize a peak, a notch in channel transfer characteristics based on the generated optimized operational bandwidth, the peak channel gain and the quality factor. Further, in generating the optimized operational bandwidth, the peak channel gain and the quality factor, the computing device 108 is configured to tune a sharpness of the peak frequency in the channel transfer characteristics by adjusting a resistance value of a resistor (R_{Tx}) in the transmitter 102. Further, in tuning the series-connected inductor (L_{Tx}) of the transmitter 102 and the parallel inductor of the receiver 104, the computing device 108 is further configured to determine an energy efficiency and data rate requirements for transferring the data between the first communicating device 101A and the second communicating device 101B. Further, the computing device 108 is configured to determine optimal values of the impedance and resistance at the transmitter 102 and the receiver side 104. Furthermore, the computing device 108 is configured to tune the transmitter 102 side resonance frequency and a receiver 104 side resonance frequency based on the determined optimal values of the impedance and the resistance and the determined energy efficiency and the data rate requirements.

Further, the computing device 108 is configured to transfer power wirelessly from the first communicating device 101A to the second communicating device 101B at the peak frequency of body resonance using a power dissipated across resistor of the receiver 104. Further, the computing device 108 is configured to measure an amount of transferred power from the first communicating device 101A to the second communicating device 101B. Further, the computing device 108 is configured to determine an optimum resistance value of the resistor across the receiver 104, a channel capacity and a suitable communicating device position. Furthermore, the computing device 108 is configured to adjust a peak power transferred between the first communicating device 101A and the second communicating device 101B based on the determined optimum resistance value of the resistor across the receiver 104, the channel capacity and the suitable communicating device position. Further, the computing device 108 is configured to adjust a channel bandwidth for data transfer based a body posture of the user. Furthermore, the computing device 108 is further configured to determine a relative orientation and a location of the first communicating device 101A and the second communicating device 101B and a body posture of the user and determine an extent of peak-signal transfer value at the body resonance frequency based on the determined relative orientation, location and the body posture. Further, the computing device 108 is configured to adjust the peak-signal transfer value at the body resonance frequency based on the determined extent and by determining termination and source resistance levels at the receiver 104 and the transmitter 102. The computing device 108 is further configured to perform interference tolerance between the first communicating device 101A and the second communicating device 101B to manage in-band interferences using techniques comprising Code-Division Multiple Access (CDMA).

Although, FIG. 1B illustrates the Communicating system 100 communicatively coupled to the server 108 via network 110, one skilled in the art can envision that the communicating system 100 may be connected to networks 110 such as, but not limited to, Wireless Personal Area Network (WPLAN), Wireless Local Area Network (W LAN), Wireless Metropolitan Area Network, Wireless Wide Area Network and the like. The network 110 may be configured to works as the infrastructure that allows multiple communicating devices 101-1, . . . , 101-N to connect and exchange information with a server 108.

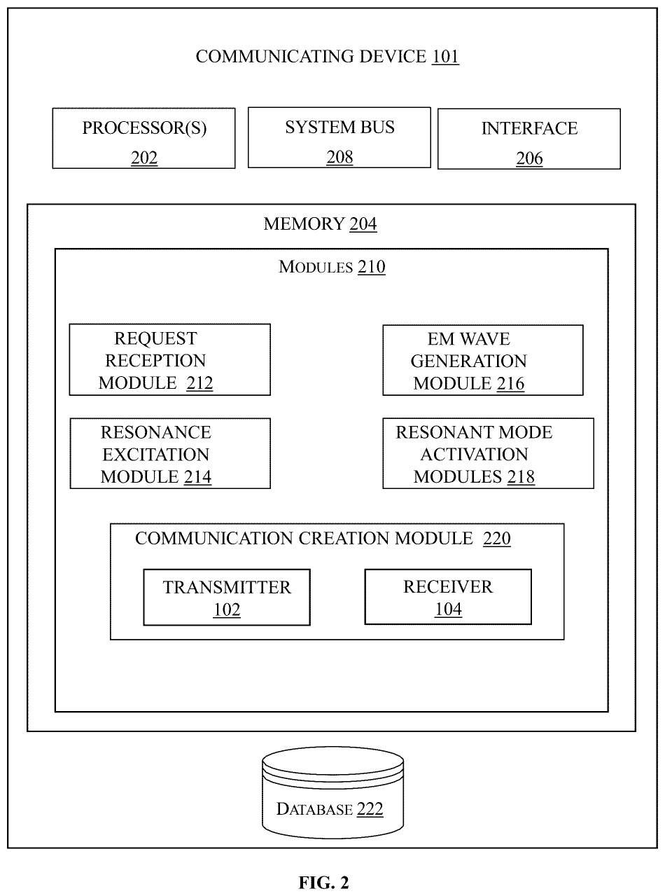

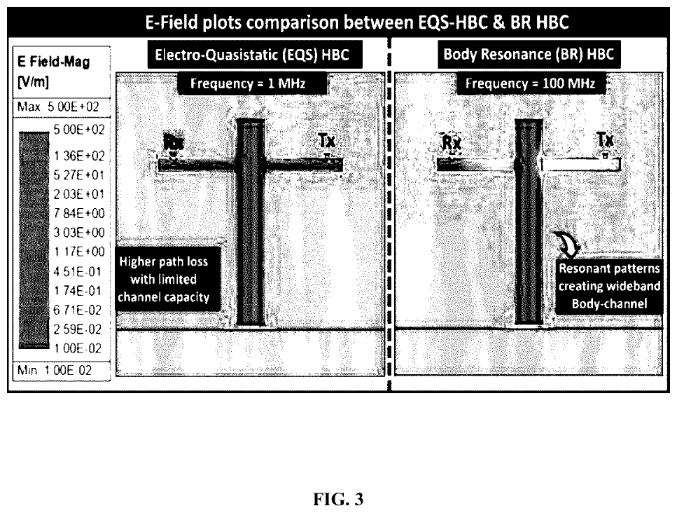

FIG. 2 illustrates a block diagram representation of an exemplary communicating device 101, such as those shown in FIGS. 1A and 1B, for communication using a human body resonance, in accordance with an embodiment of the present disclosure. In an embodiment a communicating device 101 includes a processor 202. Further, the communicating device 101 includes a memory 204 coupled to the processor 202. The memory 204 includes processor-executable instructions in the form of one or more modules 210. The one or more modules 210 may include such as, but not limited to, a request reception module 212, a resonance excitation module 214, an EM wave generation module 216, a resonant mode activation module 218, and a communication creation module 220.

Further, the request reception module 212 is configured to receive a request for transferring the data from the first communicating device 101A to the second communicating device 101B via the conducting medium 106. The request may include data such as, but not limited to, source device ID, destination device ID, type of data, data size and the like.

Further, during transmission of data, the EM wave generation module 214 is configured to excite the conducting medium 106 by transmitting electromagnetic (EM) signals to a surface of the conducting medium 106 to generate a transmitter side resonance. The transmitter side resonance includes a transmitter side resonance frequency. Further, the EM wave generation module 214 is configured to generate resonant EM wave patterns on the conducting medium 106 to establish a broadband communication channel with the conducting medium 106 based on the generated transmitter side resonance. The resonant Electromagnetic (EM) wave patterns represent the propagation profile of different modes of the EM wave. Modes of EM wave may include, but not limited to, transverse electric (TE), transverse magnetic (TM), and transverse electromagnetic (TEM), and any other mixed modes. Modes of EM wave may also include associated electric, magnetic fields when the EM wave resonates the conducting medium 106 like the human body 106. These patterns are generated by feeding EM waves (frequencies that enables the resonant modes) to the surface of the human body 106.

In another embodiment, during reception of data, the EM wave generation module 214 is configured to generate a receiver 104 side resonance frequency corresponding to the transmitter 102 side resonance frequency and the body resonance frequency using a high impedance termination circuit.

Further, the resonance excitation module 216 may be configured to synchronize transmitter side 102 resonance frequency with determined peak frequency of the body resonance and the receiver side 104 resonance frequency by tuning the series-connected inductor (L_{Tx}) of a transmitter 102 and the parallel inductor (L_{RX}) of receiver 104.

Further, the resonant mode activation module 218 may be configured to activate resonant mode by synchronizing the transmitter side 102 resonance frequency with the determined peak frequency of the body resonance and the receiver side 104 resonance frequency. The synchronization refers to the tuning of transmitter 102 and receiver side 104 resonance frequencies with the body resonance peak frequency to maximize the peak signal transfer for communication and maximum power transfer for powering. Synchronization at a specific body resonance peak frequency may be achieved by tuning the impedances at the transmitter 102 and receiver 104.

Furthermore, the resonant mode activation module 218 may be configured to generate an optimized operational bandwidth, a peak channel gain and a quality factor for data transfer between the first communicating device 101A and the second communicating device 101B based on the synchronization. Further, the communicating device 101 may be configured to position the first communicating device 101A and the second communicating device 101B to optimize a peak, a notch in channel transfer characteristics based on the generated optimized operational bandwidth, the peak channel gain and the quality factor. A peak in signal transfer indicates a frequency range that is amplified or boosted. Further, a notch signifies a frequency range that is attenuated or weakened.

Further, the communication creation module 220 is configured to establish the broadband communication channel with the first communicating device 101A based on the body resonance frequency. includes the transmitter 220-1 and the receiver 220-2. The transmitter 220-1 is configured to transmit the data from one or more communicating devices 101-1, . . . , 101-N and the receiver 220-2 is configured to receive the data from one or more communicating devices 101-1, . . . , 101-N. The data includes, but are not limited to, text, authentication, location information, audio, and video and the like.

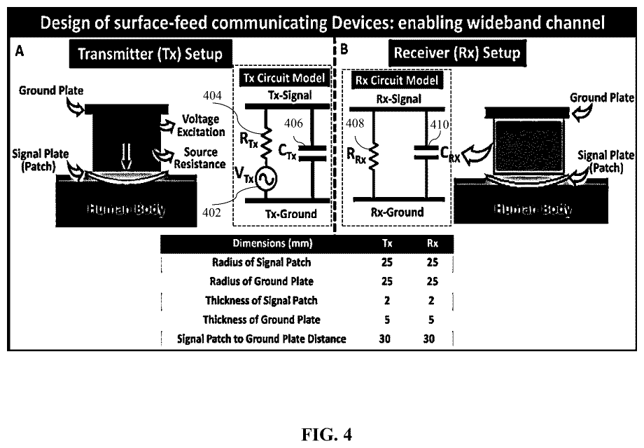

FIG. 3 illustrates an EM field intensity map representation comparison between a conventional Electro-Quasistatic (EQS) HBC and a Body Resonance (BR) HBC, in accordance with an embodiment of the present disclosure. A Human Body Communication (HBC) is an alternative to the communication by Radio Frequency (RF) based techniques such as, but not limited to Bluetooth and the like. Further, higher power consumption in conventionally available Radio Frequency (RF) communication directed data transfer techniques to shift towards the Human Body Communication (HBC).

The HBC utilises conducting properties of human body to provide wireless connectivity between communicating body wearable devices 101-1, . . . , 101-N. Referring to the FIG. 3, the HBC, in the conventional communication system may be configured to use Electro-Quasistatic (EQS) technique for communication between the communicating devices 101-1, . . . , 101-N. The EQS refers to a short-range, secure communication technique which functions on utilising conductive properties of the human body to transmit low-frequency electrical signals internally. FIG. 3 depicts an execution and implementation of the Body Resonance HBC and its benefits over EQS HBC through the comparison of E-field plots. The Body Resonance in HBC refers to synchronisation of resonant frequency of a transmitter 102 and resonant frequency of the receiver 104 with resonant frequency of the human body. Further, in an embodiment, a subject (such as a user or a human body or conducting medium 106) is in T-posture, a transmitting device (such as the transmitter 102) is placed at the wrist of one arm and a receiving device (such as the receiver 104) is placed at the wrist of another arm. An implementation is numerically simulated by, for example, but not limited to, a Finite Element Method-based electromagnetic solver, Ansys High-Frequency Structure Simulator (HFSS). The finite element based electromagnetic solver is a software tool that utilizes the finite element method (FEM) to analyse and predict the behaviour of electromagnetic (EM) fields and Ansys HESS is a software tool designed for simulating the behaviour of electromagnetic (EM) fields in high-frequency applications. A cross-cylindrical human body model, with tissue properties adapted from one or more database such as, but not limited to, Gabriel database and model accuracy, confirmed through comparison of electric field and current distribution with Visual Human Project (VHP) Female model available at NEVA EM, is used for numerical simulations. The VHP may include project which has created detailed, public-domain imagery of a whole male and female body to form a digital atlas of human anatomy. In an embodiment, Body Resonance HBC with its ability to provide approximately ˜15-20 dB lower loss (i.e., ˜10× improvement in a Signal-to-Noise Ratio SNR) than the conventional EQS-HBC for a wider bandwidth i.e., from about 50 MHz to 150 MHz (i.e., ˜10× improvement in bandwidth), the Body Resonance HBC (BR-HBC) with its approximately 30× improvement in channel capacity, is enabling high-speed body-centric communication, as illustrated in FIG. 3.

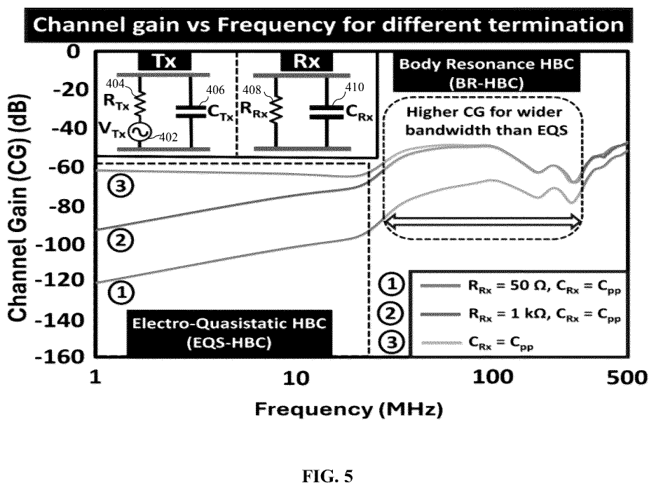

FIG. 4 illustrates an exemplary schematic diagram representation of a communication system 100 circuitry and a design of surface feed communicating devices in a Body Resonance (BR) HBC, in an accordance with an embodiment of the present disclosure. In an embodiment, wearable watch-shaped surface feed communicating device (such as the transmitter 102) is designed to feed Electromagnetic (EM) signals to surface of a human body 106 (such as the conducting medium 106). The transmitter 102 of the first communicating device 101A includes a surface-mounted parallel-plate transmitter device configured to couple the EM signals in the range of 30 MHz to 300 MHz. Further, the Electromagnetic (EM) signals, when passed through the human body 106, may form a broadband channel by utilizing formed resonance patterns the human body 106 due to EM signals. The surface feed communicating device 102 includes, a parallel-plate model customised using two copper discs of radius 2.5 cm. The copper discs of surface feed communicating device 102 may have thickness of, but not limited to, 2 mm and 5 mm. Further, in an embodiment, the disc with 2 mm thickness, semicircular in shape, and may be referred as signal plate (patch) is curved on arm. Furthermore, the disc with 5 mm thickness, may be referred as ground plate is placed parallelly 3 cm away from the curved disc. Further, in an embodiment, the curved plate (signal plate) in particular, is supplied with an AC source of 1V amplitude and 50Ω source resistance for signal generation. However, enabling a broadband channel utilizing BR HBC is not limited to the parallel plate models. At the transmitter side 102, a signal plate (patch) is used to couple the EM signal to the human body 106 and a ground plate is used to emulate the floating ground of a wearable transmitter 102. An AC voltage source (V_{Tx}) 402 of amplitude 1 V with a source resistance (R_{Tx}) 404 of 50 22 is applied between the signal patch and the floating ground of the transmitter 102 to generate EM signals of desired frequencies. The capacitance (C_{Tx}) 406 emulates the function of intrinsic capacitance resulting from the device dimension i.e., parallel plate configuration of the transmitter 102. Further, at the receiver side 104, the transmitter 102 signal gets picked up by a signal plate (patch) from the human body 106, and a ground plate is used to emulate the floating ground of a wearable receiver 104. The received voltage is calculated across the lumped impedance (R_{Rx} 408 in parallel with C_{Rx} 410) by integrating the complex magnitude of the electric field between the signal and the ground.

FIG. 5 illustrates an exemplary schematic diagram representation of comparison of channel gain between an Electro-Quasistatic (EQS) HBC and a Body Resonance (BR) HBC with plurality of termination impedances at a receiver 104 end, in accordance with an embodiment of the present disclosure. In an embodiment, a channel capacity may be improved by using various techniques. The techniques may include determination of termination impedance at receiver 104 end of a communicating device 101-1, . . . , 101-N. The termination impedance is determined from the notion of maximizing the signal pickup at the receiver 104 for a voltage mode communication at an operating frequency range. Since, from the voltage division, a high impedance termination at the receiver 104 offers more voltage across it hence, a higher termination impedance can improve the received voltage. Further, by utilising a low impedance 404 (R_{Tx}=50Ω) excitation at the transmitter 102 and a high impedance resistive reception 408 or capacitive 410 reception at the receiver 104 may optimize the channel gain benefits in BR HBC. The channel gain improvement for wide bandwidth may be achieved by using higher impedance resistive termination over lower impedance termination in BR HBC. Further, the channel gain benefits of EQS HBC may be combined with channel gain of BR HBC by a low-impedance excitation at the transmitter 102 and a high-impedance capacitive pickup at the receiver 104. Further, to enable a low loss, broadband body-channel (ranging from tens of kHz to hundreds of MHz) by combining the benefits of EQS HBC with BR HBC, high impedance capacitive termination is required at the receiver 104. Specifically, the dependency of the channel capacity on the choice of termination impedance is depicted in FIG. 5. The BR frequency regime, even with a 50Ω termination, can offer a lower-loss, wide-band channel than the EQS frequencies. Higher impedance (1 kΩ) yet resistive termination offers channel gain improvement for a wide bandwidth over lower impedance termination in BR frequencies. With a low-impedance excitation at the Tx 102 and a high-impedance capacitive pickup at the Rx 104, the channel gain benefits of the EQS regime can be combined with BR HBC to enable a further broadband channel ranging from tens of kHz to hundreds of MHz.

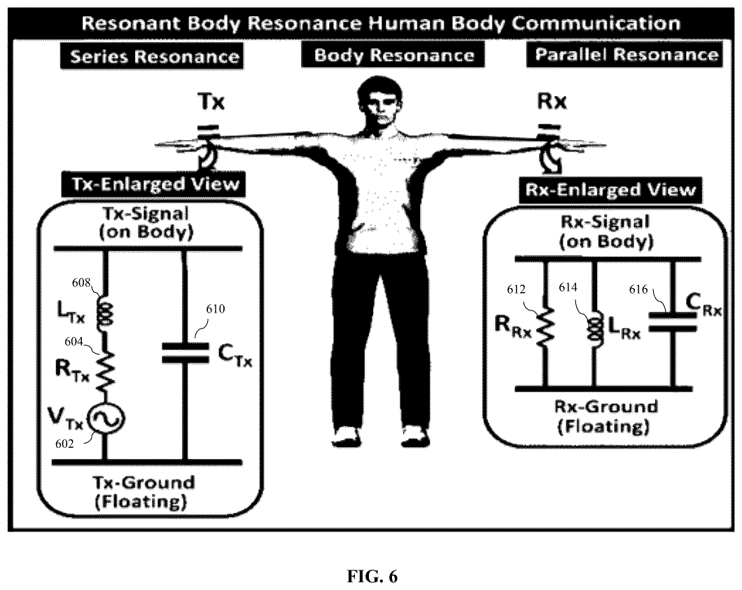

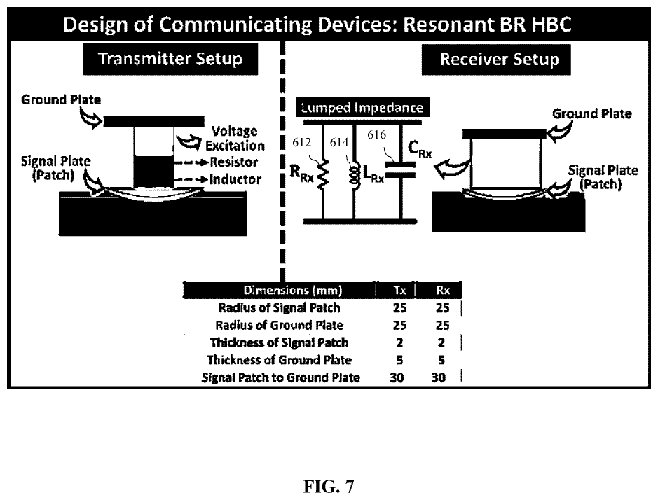

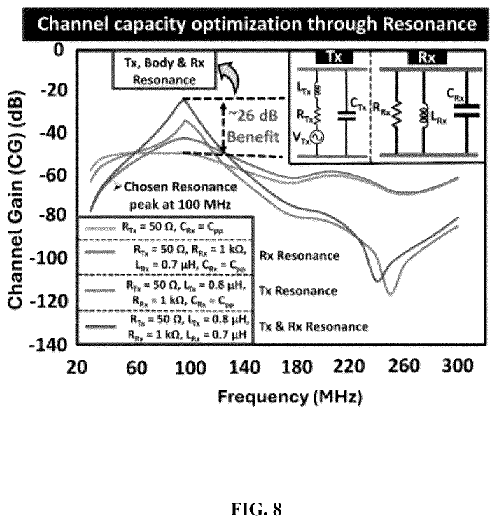

FIG. 6 illustrates an exemplary schematic diagram representation of circuitry of Resonance Human Body Communication, in accordance with an embodiment of the present disclosure. In an embodiment, a channel gain is achieved by enabling a resonant mode of BR HBC. Resonance in electronics circuits is defined as a phenomenon when impedances of circuit elements cancel each other. Resonance is attained when the impedance between the transmitter 102 and the receiver 104 in particular, of a circuit is almost zero. Referring to FIG. 6, high-speed data transfer through the human body 106 is enabled by synchronizing the resonance at the transmitter 102 and receiver side 104 with the body resonance peak. The series-connected inductor (L_{Tx}) 608 at the transmitter 102 and parallel-connected inductor (L_{Rx}) 614 at the receiver 104 cancel out capacitive reactance components of each other. Further, to enable resonance in BR-HBC from the transmitter side, a lumped inductor element (L_{Tx}) 608 is added in series with R_{Tx}. Furthermore, the resonance mode from the receiver 104 side is enabled, via the inclusion of a lumped impedance that emulates a parallel resonance at the receiver 104. Further, synchronizing the resonance frequency from the transmitter 102 with the chosen peak frequency of body resonance (100 MHz) and the resonance frequency from the receiver 104, a resonant BR HBC mode is enabled. The technique for boosting the channel gain even further in the BR regime is implemented by enabling a resonant mode of BR-HBC. The flexibility in tuning bandwidth and the ability to support high-speed data transfer through the human body is enabled by synchronizing the resonance at the transmitter and receiver side with the body resonance peak as conceptualized in FIG. 6. The resonant frequency at the transmitter side is adjusted to the peaks of the body resonance by addition of an inductor in series with the source resistance of the transmitter 102. The receiver side executes resonance by adding an inductor in parallel to the load. The design of communicating devices that are used to enable resonant BR HBC is shown in FIG. 7. The comparative analysis of channel gain characteristics for non-resonant and resonant BR-HBC from the numerical EM simulation is illustrated in FIG. 8. We observe that with the proposed resonant mode of communication, by aligning the three resonances, about 26 dB improvement in channel gain is achievable at the chosen resonance peak frequency (100 MHz) compared to the non-resonant mode of BR-HBC.

FIG. 6 illustrates an exemplary schematic diagram representation of Resonant Body Resonance Human Body Communication along with the circuitry at the transmitter and receiver side, in accordance with an embodiment of the present disclosure. In an embodiment, further improvement (˜20×) in channel gain over BR-HBC with an adaptably tunable feature of channel bandwidth and peak signal transfer is achieved by enabling a resonant mode of BR-HBC. Resonance in electronic circuits is defined as a phenomenon when impedances of circuit elements cancel each other, resonance is attained when the difference in impedance between input and output; transmitter and receiver in particular, of a circuit, is almost zero. Referring to FIG. 6, leveraging the presence of the body resonance peak in the BR frequency regime, low-loss (˜15-20 dB lower than Electro-Quasistatics (EQS) Human Body Communication (HBC)), high-speed data transfer (>100's Mbps) through the human body is enabled by synchronizing the resonance at the transmitter and receiver side with the body resonance peak.

FIG. 7 illustrates an exemplary schematic diagram representation of communicating devices 101 at a transmitting end and a receiving end of Human Body Communication, in an accordance with an embodiment of the present disclosure. In an embodiment, a design of communicating devices used to enable resonant BR HBC is depicted. Further, FIG. 7 represents the design of transmitter 102 and receiver 104 along with circuit schematics for excitation and pickup to enable resonant BR-HBC. In an embodiment, Body Resonance is achieved by addition of an inductor in series with the source resistance of a transmitter 102. The receiver 104 side executes resonance by adding an inductor in parallel to a load of circuit. A series-connected inductor (L_{Tx}) 608 at the transmitter 102 and a parallel-connected inductor (L_{Rx}) 614 at the receiver 104 cancel out capacitive reactance components of each other. Furthermore, to enable resonance in BR-HBC from the transmitter side, a lumped inductor element (L_{Tx}) 608 is added in series with R_{Tx} 604. Furthermore, resonance mode from the receiver 104 side is enabled, by an inclusion of a lumped impedance 614 that emulates a parallel resonance at the receiver 104.

FIG. 8 illustrates an exemplary schematic diagram representation of a channel capacity optimization through resonance in Human Body resonance, in accordance with an embodiment of the present disclosure. In an embodiment, a comparative analysis of channel gain for non-resonant and resonant BR-HBC from numerical EM simulation is illustrated. The channel gain refers to strength and quality of signal received by receiver 104 from transmitter 102. Further, in an embodiment, channel capacity is increased by achieving a resonance in BR HBC. The channel capacity indicates an amount of information that may be transmitted from transmitter 102 to receiver 104, with minimal errors. BR HBC may be configured to provide approximately 30× improvement in channel capacity via the approximately 10× improvement in operational bandwidth (BW) and approximately 10× improvement in channel gain (i. e., ˜10× more signal) over EQS HBC, according to Shannon-Hartley theorem. Furthermore, a resonance of communicating device is achieved when a frequency of a transmitter 102 and a frequency of a receiver 104 are synchronised. Further, in an embodiment, a resonant mode of BR HBC may be enabled by synchronizing the resonance frequency from the transmitter 102 with the chosen peak frequency of body resonance (100 MHz) and the resonance frequency from the receiver 104. An enablement of the resonant mode of the BR HBC improves a channel gain by 26 dB, compared to a non-resonant mode of BR HBC. The non-resonant mode of BR HBC refers to a state where frequencies of transmitter 102, receiver 104 and body resonance are not synchronised. The channel gain improvement in BR HBC is achieved by aligning resonance of transmitter 102, receiver 104, transmitter 102 and receiver 104 together.

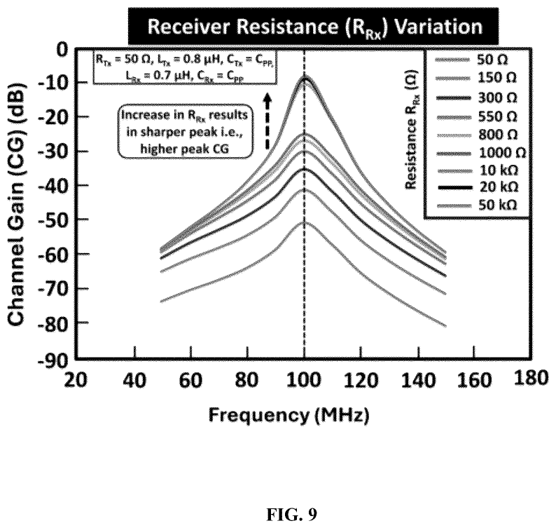

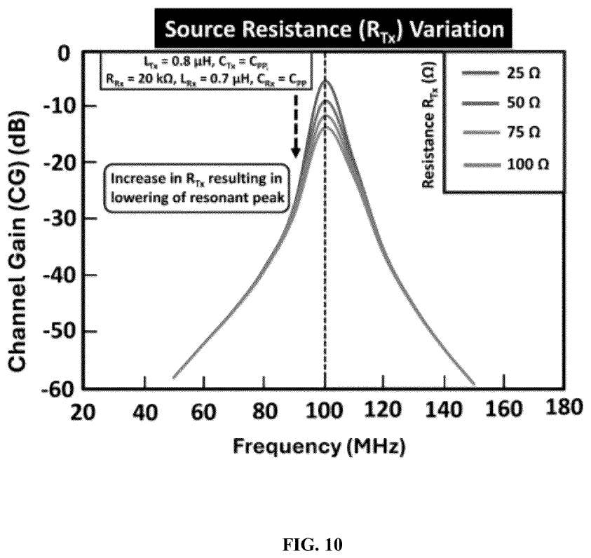

FIG. 9 illustrates an exemplary graphical representation of a receiver resistance variation for obtaining a suitable channel gain in e Human Body resonance, in an accordance with an embodiment of the present disclosure. In wireless communication, bandwidth refers to the maximum rate at which data can be reliably transmitted over a specific channel. The bandwidth is the data capacity of wireless connection. Further, the quality factor, refers to efficiency of a signal transmitted over a channel. The quality factor describes about strength and clarity of a signal during transmission. Further, a channel gain may be achieved by adjusting a value of source (i.e. transmitter 102) resistance (R_{Tx}) 404 and termination (i.e. receiver 104) resistance (R_{RX}) 408. The channel gain is maximum when the transmitter resonance, receiver resonance and the resonance of the human body are synchronised. Further, synchronisation of a communicating device is obtained by adjusting transmitter resistance (R_{RX}) 408 to lower value and receiver resistance (R_{RX}) 408 to higher value. In an embodiment, a frequency (100 MHz) at which the human body resonates is determined for peak signal transfer. The peak-signal transfer at the resonance frequency may be adjusted through the flexibility in the choice of transmitter and receiver resistances. Referring to FIG. 9, by keeping the resonating frequency constant, the sharpness of the peak (i.e., quality factor (Q)) may be improved further by increasing receiver resistance (R_{Rx}) 408. In an embodiment, an optimal setup for a similar sized (fixed CPP i.e., C_{Tx} and C_{Rx}) communicating devices is presented with R_{Tx}=50 Q, L_{Tx}=0.8 μH, R_{Rx}=20 kΩ, L_{Rx}=0.7 μH that may improve the channel gain to-9 dB (41 dB more than BR-HBC). Further, an increase in receiver resistance (R_{Rx}) 408 results in higher channel gain of an EM wave signal to be transmitted. The higher channel gain is obtained by synchronisation as described above. Depending upon the energy efficiency and data rate requirements, its resonance frequency can be tuned by an optimal choice of inductors. The peak-signal transfer at the resonance frequency can be adjusted through the flexibility in the choice of termination and source resistance at the receiver and transmitter side respectively, shown in FIGS. 9 and 10.

FIG. 10 illustrates an exemplary graphical representation of a source (i.e. transmitter) resistance variation for obtaining suitable channel gain in Human Body Resonance, in an accordance with an embodiment of the present disclosure. In wireless communication, bandwidth refers to the maximum rate at which data can be reliably transmitted over a specific channel. The bandwidth is the data capacity of wireless connection. Further, the quality factor, refers to efficiency of a signal transmitted over a channel. The quality factor describes a strength and a clarity of an EM signal during transmission. In an embodiment, a channel gain may be obtained by adjusting a value of source (i.e. transmitter) resistance and termination (i.e. receiver) resistance. The channel gain is maximum when the transmitter 102, the receiver 104 and the resonance of the human body 106 are synchronised. Further, synchronisation of a communicating device 101 is achieved by adjusting transmitter resistance 604 to lower value and receiver resistance 612 to higher value. The source resistance (Transmitter resistance) (R_{Tx}) 604 at the transmitter 102 may be configured to be 50Ω or lower while the receiver resistance (R_{Rx}) 612 may be configured to be 10 KΩ or higher. In an embodiment, a frequency (100 MHz) at which the human body resonates is determined for peak signal transfer. The peak-signal transfer at the resonance frequency may be adjusted through the flexibility in the choice of transmitter and receiver resistances. To achieve a higher peak signal transfer, source resistance (Transmitter resistance) (R_{Tx}) 604 at the transmitter may be configured to be 50Ω or lower while the receiver resistance (R_{Rx}) may be configured to be 10 KΩ or higher. Referring to FIG. 10, decrease in transmitter resistance (R_{Tx}) 604 results in higher channel gain of a signal to be transmitted. The higher channel is achievable by achieving the synchronisation.

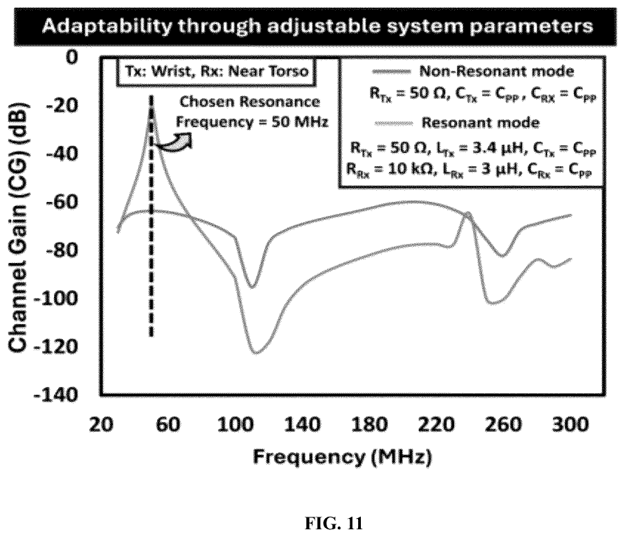

FIG. 11 illustrates an exemplary graphical diagram representation of an adaptability of resonant mode with changes in the location of the devices and the subject's posture via suited adjustment of system parameters, in accordance with an embodiment of the present disclosure. In an embodiment, a location of a peak and a notch in channel transfer characteristics may be tracked and adjusted to optimize peak channel gain and bandwidth providing optimum positioning for communicating devices 101-A, . . . , 101-N. The peak in signal transfer indicates a frequency range that is amplified or boosted. Further, the notch signifies a frequency range that is attenuated or weakened.

Further, a communicating device 101-A, . . . , 101-N may be adaptable to change peak frequency for communication with a change in the location of devices. An adaptability of a communicating device is associated with the flexibility in tuning a series inductance at a transmitter 102 and a parallel inductance at a receiver 104. Further, an adaptability of the communicating device to positioning and posture of a human body extends scope of application from watch-shaped wearables, placed at the wrists to any other pairs of wearables placed at any location of the human body such as, but not limited to, waist-belt, headset, a pair of shoes, a wristband and headset. Furthermore, in an embodiment, posture of a human body also has a decisive role on transfer characteristics of peak signal.

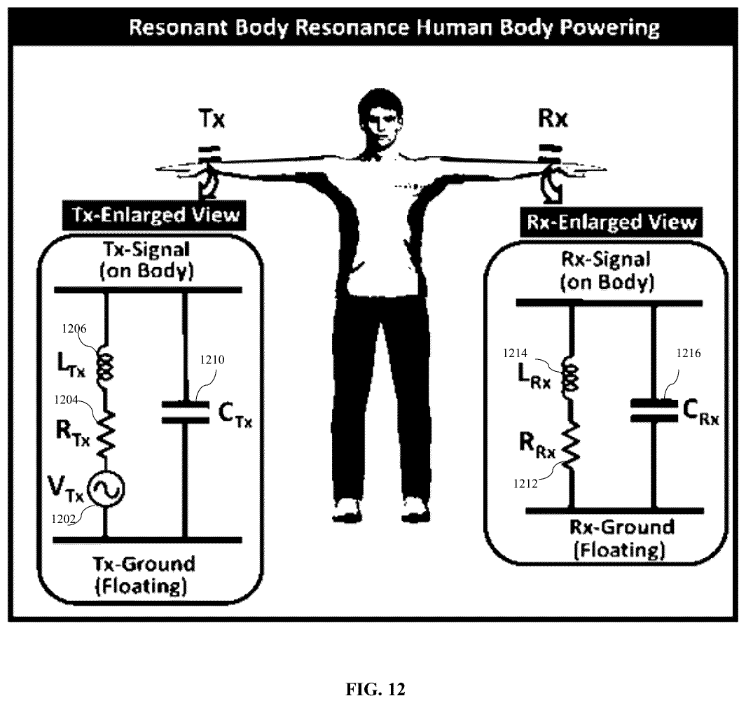

FIG. 12 illustrates an exemplary schematic diagram representation of power transfer between a first communication device 101A and a second communication device 101B, in accordance with an embodiment of the present disclosure. In an embodiment, a resonant body resonance human body powering may include a transmitter 102 and a receiver 104. In an embodiment maximum power transfer is obtained by synchronisation of a communicating system 100. The synchronisation is obtained by adjusting transmitter resistance to lower value and receiver resistance to higher value. In an embodiment, a frequency (100 MHz) at which the human body resonates is determined for peak signal transfer. The peak-signal transfer at the resonance frequency may be adjusted through the flexibility in the choice of transmitter and receiver resistances. The power is transferred wirelessly by leveraging the presence of conducting medium like human body 106 i.e., the wearable transmitter 102 transfers power via human body 106 to wearable receiver 102 by utilizing the Body Resonance Human Body Powering (BR-HBP).

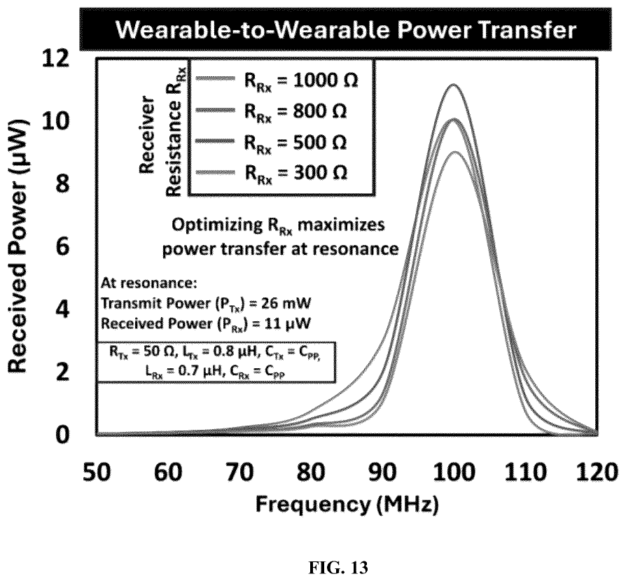

FIG. 13 illustrates an exemplary graphical diagram representation of implementation of power transfer via a resonant mode of powering from a wearable transmitter 102 to a wearable receiver 104, in accordance with an embodiment of the present disclosure. In an embodiment, the power is transferred wirelessly from a first communicating device 101A to a second communicating device 101B at the peak frequency of body resonance using a power dissipated across resistor of the receiver 104.

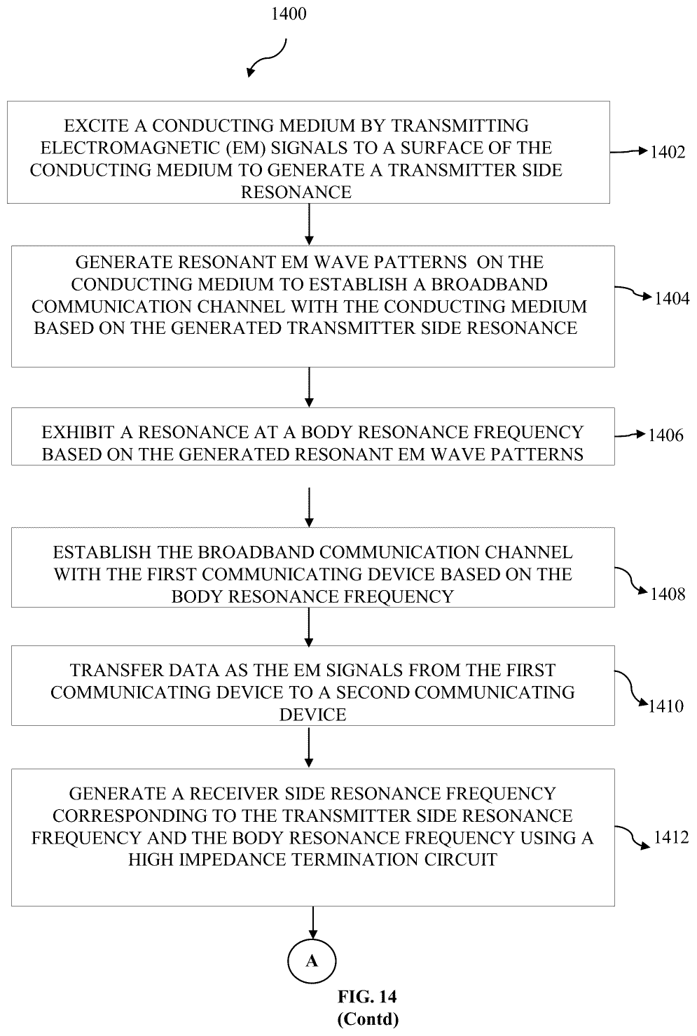

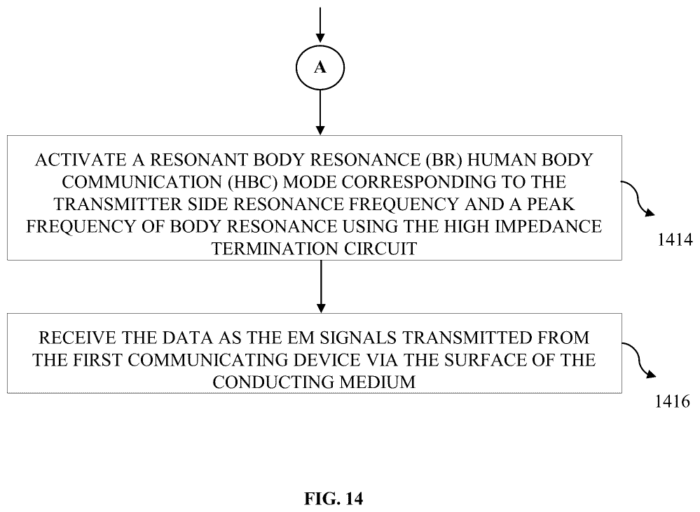

FIG. 14 illustrates an exemplary process flow diagram representation depicting a process of data transfer using human body resonance, in accordance with an embodiment of the present disclosure. As illustrated in FIG. 14, the following steps may be implemented.

At step 1402, the method 1400 includes exciting, by a first communicating device 101A including a transmitter 102, a conducting medium 106 by transmitting electromagnetic (EM) signals to a surface of the conducting medium 106 to generate a transmitter side resonance. The transmitter side resonance includes a transmitter side resonance frequency, At step 1404, the method 1400 includes generating, by the first communicating device including the transmitter 102, resonant EM wave patterns on the conducting medium 106 to establish a broadband communication channel with the conducting medium 106 based on the generated transmitter side resonance, At step 1406, the method 1400 includes exhibiting, by the conducting medium 106, a resonance at a body resonance frequency based on the generated resonant EM wave patterns, At step 1408, the method 1400 includes establishing, by the conducting medium 106, the broadband communication channel with the first communicating device 101A based on the body resonance frequency, At step 1410, the method 1400 includes transferring, by the conducting medium 106, data as the EM signals from the first communicating device 101A to the second communicating device 101B, At step 1412, the method 1400 includes generating, by the second communicating device 101B including a receiver 104, a receiver side resonance frequency corresponding to the transmitter side resonance frequency and the body resonance frequency using a high impedance termination circuit, At step 1414, the method 1400 includes activating, by the second communicating device 101B including a receiver 104, a resonant body resonance (BR) human body communication (HBC) mode corresponding to the transmitter side resonance frequency and a peak frequency of body resonance using the high impedance termination circuit, At step 1416, the method 1400 includes receiving, by the second communicating device 101B including the receiver 104, the data as the EM signals transmitted from the first communicating device 101A via the surface of the conducting medium 106. The method 1400 includes determining, by a processor 202 of a communicating device 101, a location of a peak frequency and a notch in a channel transfer characteristics. The method 1400 includes adjusting, by the processor 202 of the communicating device 101, the determined location of the peak frequency and the notch based on required energy efficiency and data transfer rate requirements. The method 1400 includes synchronizing, by the processor 202 of the communicating device 101, the transmitter side 102 resonance frequency with the determined peak frequency of the body resonance and the receiver side 104 resonance frequency by tuning a series-connected inductor (L_{Tx}) of the transmitter 102 and a parallel inductor of the receiver 104. The method 1400 includes generating, by the processor 202 of the communicating device 101, an optimized operational bandwidth, a peak channel gain and a quality factor for data transfer between the first communicating device 101A and the second communicating device 101B based on the synchronization. The method 1400 includes positioning, by the processor 202 of the communicating device 101, the first communicating device 101A and the second communicating device 101B to optimize a peak, a notch in the channel transfer characteristics based on the generated optimized operational bandwidth, the peak channel gain and the quality factor. The method 1400 includes tuning, by the processor 202 of the communicating device 101, a sharpness of the peak frequency in the channel transfer characteristics by adjusting a resistance value of a resistor (R_{Tx}) in the transmitter 102. The method 1400 includes determining, by the processor 202 of the communicating device 101, an energy efficiency and data rate requirements for transferring the data between the first communicating device 101A and the second communicating device 101B. The method 1400 includes determining, by the processor 202 of the communicating device 101, optimal values of the impedance and resistance at the transmitter 102 and the receiver side 104. The method 1400 includes tuning, by the processor 202 of the communicating device 101, the transmitter 102 side resonance frequency and a receiver side 104 resonance frequency based on the determined optimal values of the impedance and the resistance and the determined energy efficiency and the data rate requirements. The method 1400 includes transferring, by the processor 202 of the communicating device 101, power wirelessly from the first communicating device 101A to the second communicating device 101B at the peak frequency of body resonance using a power dissipated across resistor of the receiver 104. The method 1400 includes measuring, by the processor 202 of the communicating device 101, an amount of transferred power from the first communicating device 101A to the second communicating device 101B. The method 1400 includes determining, by the processor 202 of the communicating device 101, an optimum resistance value of the resistor across the receiver 104, a channel capacity and a suitable communicating device position. The method 1400 includes adjusting, by the processor 202 of the communicating device 101, a peak power transferred between the first communicating device 101A and the second communicating device 101B based on the determined optimum resistance value of the resistor across the receiver 104, the channel capacity and the suitable communicating device position. The method 1400 includes adjusting, by the processor 202 of the communicating device 101, a channel bandwidth for data transfer based a body posture of the user. The method 1400 includes determining, by the processor 202 of the communicating device 101, a relative orientation and a location of the first communicating device 101A and the second communicating device 101B and a body posture of the user. The method 1400 includes determining, by the processor 202 of the communicating device 101, an extent of peak-signal transfer value at the body resonance frequency based on the determined relative orientation, location and the body posture. The method 1400 includes adjusting, by the processor 202 of the communicating device 101, the peak-signal transfer value at the body resonance frequency based on the determined extent and by determining termination and source resistance levels at the receiver 104 and the transmitter 102.

The present system relates to the efficient techniques of enhancing the channel capacity of a body-communication link to escalate the development of novel assistive technologies toward augmented living. Definitively, the present methodology illustrates, for the first time, the feasibility of enabling a low-loss (˜15-20 dB lower than Electro-Quasistatics (EQS) Human Body Communication (HBC)), high-speed (>100's Mbps), broadband (˜50-150 MHz) link for communication between the battery-powered wearable devices and wireless power transfer among wearables by utilizing HBC and powering in the Body Resonance (BR) frequency regime. The key attributes of this methodology include but are not limited to the following: techniques for efficient coupling of signal to and pickup from the surface of the human body to create a low-loss, wide band body channel, selection of excitation and termination impedances to enable such a broadband channel; increase in body-channel capacity by ˜30× via BR-HBC than EQS HBC; enabling resonant mode of BR-HBC for channel capacity optimization, tuning flexibility in bandwidth and quality factor of transfer characteristic with the resonant mode at frequencies in the Body-Resonance regime; high-Speed (>100's of Mbps) body-centered communication link; channel capacity dependency on the location and relative orientation of the communicating devices; adaptive adjustment of the channel bandwidth with user's body posture; and wireless power transfer among wearables using resonant body resonance. Therefore, the present system presents techniques for increasing the body channel capacity by utilizing the resonance phenomena of the human body. With the proper choice of mode of excitation and pickup from the human body, this present system offers an adaptive wide-band channel for high-speed body-centric communication and wireless power transfer by utilizing resonance mode of Body Resonance Human Body Communication. The present system enables high-speed digital data transfer among body-connected devices and possibly even wireless charging of multiple wearables from one wearable.

The present communication system 100 provides techniques for low-loss, wide-band, high-speed links for the information exchange and wireless powering among the wearables, via Body Resonance Human Body Communication and Powering. The act of exciting the human body with wearables such as a transmitter 102 that feeds EM signals to the surface of the body 106 and creates resonant EM wave patterns on the body 106 that enables a broadband channel with lower transmission path loss than conventional Electro-Quasistatics (EQS) frequencies (≤30 MHz) is presented.

Further, the present communication system 100 enables a wide-band body channel via the use of a low-impedance excitation at the transmitter and high-impedance termination at the receiver. For a 50Ω termination at the receiver, the choice of an operational frequency between 30 MHz to 300 MHz or any sub-band including but not limited to 50 MHz to 150 MHz, illustrated in FIG. 5, i.e., where the body 106 exhibits resonance phenomena, gives a lower loss for a wider operational bandwidth than EQS. Using a higher still resistive impedance at the receiver 104 in the said frequency regime channel gain improvement is achievable for a wider bandwidth.

With the capacitive termination at the receiver 104, the optimum body resonance may be combined to support a further broadband channel ranging from few tens of kHz to hundreds of MHz. A surface-mounted parallel-plate transmitter device, which may couple EM signals from 30 MHz to 300 MHz and enable such a resonance mode of body, is disclosed. The applicability of the present method 1400 of excitation is not limited to exciting the human body 106 but includes other cylindrical conducting objects of comparable body dimensions as well, exhibiting similar resonance phenomena.

A parallel-plate model for the receiver 104 having the ability to pick up EM signals from the surface of a cylindrical conducting object like the human body, excited by the surface-mounted transmitter, is presented. This technique is not limited to the use of parallel plate design but includes other designs of devices as well. The present system includes the surface-feed mode of excitation, other feeding techniques such as for example, but not limited to, inline-feed or penetration feed that may create such a broadband channel are claimed. Transmitter side resonance is presented to maximize the on-body signal strength by aligning the resonance frequency at the transmitter with a chosen peak frequency of body resonance. The presented implementation uses a series resonance at the Tx, but the scope of this technique is not limited to it, and any combinations leading toward resonance at Tx suffice. Tunability feature of the inductor and/or capacitor are to be used to adjust the resonant frequency and the attached resistor is to be tuned to optimize the operational bandwidth or quality factor depending on application requirements.

The choice of inductor through impedance matching to minimize the reflections. Receiver side resonance to maximize the signal pickup by synchronizing the resonance frequency at the receiver with a chosen peak frequency of body resonance. The presented implementation uses a parallel inductor at the receiver, but the scope of this technique is not limited to it, and any combinations leading toward resonance at Rx suffice. Tunability feature of the inductor and/or capacitor are to be used to adjust the resonant frequency and the attached resistor is to be tuned to optimize the operational bandwidth or quality factor depending on application requirements. Choice of inductor through impedance matching to minimize the reflections. Resonant tuning at the transmitter and/or at the receiver in conjunction with the body resonance to maximize channel gain via enabling a resonant mode for Body Resonance Human Body Communication, is presented. This includes but not limited to the presented series resonance at the transmitter, parallel resonance at the receiver and any other possible combinations leading towards single or possibly even multiple order resonances at the transmitter and/or receiver for either enhancing the quality factor or bandwidth enhancement.

The present system provides energy-efficient information exchange through the human body using Body Resonance Human Body Communication. The present system provides communication using resonance phenomena of the human body. The present system further provides data transfer through the body leveraging conducting properties of the human body, wide bandwidth communication channel for body-centric applications, ability to transmit and receive signals over a broad frequency range, constant tuning or adjustment of resonant frequency is not required, increased number of inter-connected wireless body-area-network devices i.e., efficient utilization of body channel bandwidth, high data rate communication, enabling hundreds of Mbps data transfer through the human body utilizing resonant peaks of the human body for high-speed data transmission, increased channel capacity, paving the way for the emergence of novel modulation schemes, accommodating an increased volume of data transmission, dependency of the channel capacity on the location and relative orientation of the on-body communication devices, and adaptability of the proposed techniques with the variations in use cases like the change in position of communicating devices and/or the user's body posture via the suited adjustment of system parameters makes it versatile and extends its scope of applicability.

The techniques for interference tolerance may include, for example, but not limited to, Code-Division Multiple Access (CDMA), which may be used in conjunction with Body Resonance to handle in-band interferences such as, a frequency modulation (FM). Wireless power transfers from one wearable to multiple wearables through the resonant mode of body resonance human body powering. The scope of further optimization in the received power to hundreds of μW or possibly even sub-tens of mW realizable and is not limited to the shown 11 μW number for the long channel of 155 cm (wrist of one arm to wrist of another arm) and can be done by adjusting the value of RRx and suited device position (i.e., for moderate and/or short length channels waist to knee, waist to the wrist, knee to ankle, etc.) to maximize peak transferred power.

Applications of this include but are not limited to the following Body-resonance enabled human-computer interactions like the human body resonates to interact with ambient intelligence, facilitating users' interaction with “smart” electronic appliances, which are present in homes, offices, restaurants, and the like. The present system discloses data and power transfer utilizing resonance of conducting structures like resonating a conducting table for charging laptops, smartphones, and wearables such as, for example, but not limited to, smartwatches, earbuds, smart glasses, and the like. The present system discloses information exchange and powering via body-conducting structure co-resonance. The present system discloses wireless charging of on-body wearables i.e., from a helmet or headset to a waistbelt or possibly to smartphones, smartwatches, smart shoes, and the like.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, and the like of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

1. A communication system for data transfer using human body communication, comprising:
a first communicating device comprises a transmitter configured to:
excite a conducting medium by transmitting electromagnetic (EM) signals to a surface of the conducting medium to generate a transmitter side resonance, wherein the transmitter side resonance comprises a transmitter side resonance frequency; and
generate resonant EM wave patterns on the conducting medium to establish a broadband communication channel with the conducting medium based on the generated transmitter side resonance;
the conducting medium communicatively coupled to the first communication device via a body communication network, wherein the conducting medium is configured to:
exhibit resonance at a body resonance frequency based on the generated resonant EM wave patterns;
establish the broadband communication channel with the first communicating device based on the body resonance frequency; and
transfer data as the EM signals from the first communicating device to a second communicating device; and
the second communicating device communicatively coupled to the first communicating device via the conducting medium, wherein the second communicating device comprises a receiver configured to:
generate a receiver side resonance frequency corresponding to the transmitter side resonance frequency and the body resonance frequency using a high impedance termination circuit;
activate a resonant body resonance (BR) human body communication (HBC) mode corresponding to the transmitter side resonance frequency and a peak frequency of body resonance using the high impedance termination circuit; and
receive the data as the EM signals transmitted from the first communicating device via the surface of the conducting medium.

2. The communication system of claim 1, wherein the transmitter comprises a series-connected inductor (L_{Tx}) connected in series with a source resistor (Rs) for adjusting the transmitter side resonance frequency with the peak frequency of body resonance.

3. The communication system of claim 1, wherein transmitter is excited with an alternating current (AC) voltage source of a defined amplitude value and a defined source resistance value (RTx).

4. The communication system of claim 1, wherein the high impedance termination circuit of the receiver comprises a parallel inductor connected in parallel to a load, wherein the parallel inductor is configured to perform optimum impedance termination by adjusting a resistive and a reactive component of the parallel inductor, and wherein the parallel inductor emulates a parallel resonance.

5. The communication system of claim 2, wherein the series-connected inductor at the transmitter and a parallel inductor (L_{Rx}) at the receiver are configured to cancel out each of their capacitive reactance components.

6. The communication system of claim 4, wherein the receiver is terminated with a lumped impedance by adjusting the resistive and the reactive component.

7. The communication system of claim 1, wherein the resonant body resonance (BR) human body communication (HBC) mode is activated by synchronizing the transmitter side resonance frequency with the determined peak frequency of the body resonance and the receiver side resonance frequency.

8. The communication system of claim 1, wherein the transmitter of the first communicating device comprises a surface-mounted parallel-plate transmitter device configured to couple the EM signals in the range of 30 MHz to 300 MHz.

9. The communication system of claim 1, wherein the conducting medium comprises one of a human body and cylindrical conducting objects of comparable body dimensions.

10. The communication system of claim 1, further comprising:
a computing device communicatively coupled to the first communicating device and the second communicating device via a communication network, wherein the computing device comprises:
a processor; and
a memory coupled to the processor, wherein the memory comprises processor-executable instructions, which on execution, cause the processor to:
determine a location of a peak frequency and a notch in a channel transfer characteristics;
adjust the determined location of the peak frequency and the notch based on required energy efficiency and data transfer rate requirements;
synchronize the transmitter side resonance frequency with the determined peak frequency of the body resonance and the receiver side resonance frequency by tuning the series-connected inductor (L_{Tx}) of the transmitter and the parallel inductor of the receiver;
generate an optimized operational bandwidth, a peak channel gain and a quality factor for data transfer between the first communicating device and the second communicating device based on the synchronization; and
position the first communicating device and the second communicating device to optimize a peak, a notch in a channel transfer characteristics based on the generated optimized operational bandwidth, the peak channel gain and the quality factor.

11. The communication system of claim 10, wherein in generating the optimized operational bandwidth, the peak channel gain and the quality factor, the computing device is configured to:
tune a sharpness of the peak frequency in the channel transfer characteristics by adjusting a resistance value of a resistor (R_{Tx}) in the transmitter.

12. The communication system of claim 10, wherein in tuning the series-connected inductor (L_{Tx}) of the transmitter and the parallel inductor of the receiver, the computing device is further configured to:
determine an energy efficiency and data rate requirements for transferring the data between the first communicating device and the second communicating device;
determine optimal values of the impedance and resistance at the transmitter and the receiver side; and
tune the transmitter side resonance frequency and a receiver side resonance frequency based on the determined optimal values of the impedance and the resistance and the determined energy efficiency and the data rate requirements.

13. The communication system of claim 10, wherein the computing device is further configured to:
transfer power wirelessly from the first communicating device to the second communicating device at the peak frequency of body resonance using a power dissipated across resistor of the receiver;
measure an amount of transferred power from the first communicating device to the second communicating device;
determine an optimum resistance value of the resistor across the receiver, a channel capacity and a suitable communicating device position; and
adjust a peak power transferred between the first communicating device and the second communicating device based on the determined optimum resistance value of the resistor across the receiver, the channel capacity and the suitable communicating device position.

14. The communication system of claim 10, wherein the computing device is further configured to:
adjust a channel bandwidth for data transfer based a body posture of the user.

15. The communication system of claim 10, wherein the computing device is further configured to:
determine a relative orientation and a location of the first communicating device and the second communicating device and a body posture of the user;
determine an extent of peak-signal transfer value at the body resonance frequency based on the determined relative orientation, location and the body posture; and
adjust the peak-signal transfer value at the body resonance frequency based on the determined extent and by determining termination and source resistance levels at the receiver and the transmitter.

16. The communication system of claim 1, wherein the conducting medium and the transmitter are excited using one of a surface-feed mode, an inline-feed mode, and a penetration feed mode.

17. The communication system of claim 13, wherein the channel capacity is dependent on the location and the relative orientation of the first communicating device and the second communicating device.

18. The communication system of claim 13, wherein the computing device is further configured to perform interference tolerance between the first communicating device and the second communicating device to manage in-band interferences using techniques comprising Code-Division Multiple Access (CDMA).

19. A method for data transfer using human body communication, comprising:
exciting, by a first communicating device comprising a transmitter, a conducting medium by transmitting electromagnetic (EM) signals to a surface of the conducting medium to generate a transmitter side resonance, wherein the transmitter side resonance comprises a transmitter side resonance frequency;
generating, by the first communicating device comprising the transmitter, resonant EM wave patterns on the conducting medium to establish a broadband communication channel with the conducting medium based on the generated transmitter side resonance;
exhibiting, by the conducting medium, a resonance at a body resonance frequency based on the generated resonant EM wave patterns;
establishing, by the conducting medium, the broadband communication channel with the first communicating device based on the body resonance frequency;
transferring, by the conducting medium, data as the EM signals from the first communicating device to a second communicating device; and
generating, by the second communicating device comprising a receiver, a receiver side resonance frequency corresponding to the transmitter side resonance frequency and the body resonance frequency using a high impedance termination circuit;
activating, by the second communicating device comprising a receiver, a resonant body resonance (BR) human body communication (HBC) mode corresponding to the transmitter side resonance frequency and a peak frequency of body resonance using the high impedance termination circuit; and
receiving, by the second communicating device comprising a receiver, the data as the EM signals transmitted from the first communicating device via the surface of the conducting medium.

20. The method of claim 19, further comprising:
determining, by a processor of a computing device, a location of a peak frequency and a notch in a channel transfer characteristics;
adjusting, by the processor of the computing device, the determined location of the peak frequency and the notch based on required energy efficiency and data transfer rate requirements;
synchronizing, by the processor of the computing device, the transmitter side resonance frequency with the determined peak frequency of the body resonance and the receiver side resonance frequency by tuning a series-connected inductor (L_{Tx}) of the transmitter and a parallel inductor of the receiver;
generating, by the processor of the computing device, an optimized operational bandwidth, a peak channel gain and a quality factor for data transfer between the first communicating device and the second communicating device based on the synchronization; and
positioning, by the processor of the computing device, the first communicating device and the second communicating device to optimize a peak, a notch in the channel transfer characteristics based on the generated optimized operational bandwidth, the peak channel gain and the quality factor.

21. The method of claim 20, wherein generating the optimized operational bandwidth, the peak channel gain and the quality factor comprises:
tuning, by the processor of the computing device, a sharpness of the peak frequency in the channel transfer characteristics by adjusting a resistance value of a resistor (R_{Tx}) in the transmitter.

22. The method of claim 20, wherein tuning the series-connected inductor (L_{Tx}) of the transmitter and the parallel inductor of the receiver comprises:
determining, by the processor of the computing device, an energy efficiency and data rate requirements for transferring the data between the first communicating device and the second communicating device;
determining, by the processor of the computing device, optimal values of the impedance and resistance at the transmitter and the receiver side; and
tuning, by the processor of the computing device, the transmitter side resonance frequency and a receiver side resonance frequency based on the determined optimal values of the impedance and the resistance and the determined energy efficiency and the data rate requirements.

23. The method of claim 20, further comprising:
transferring, by the processor of the computing device, power wirelessly from the first communicating device to the second communicating device at the peak frequency of body resonance using a power dissipated across resistor of the receiver;
measuring, by the processor of the computing device, an amount of transferred power from the first communicating device to the second communicating device;
determining, by the processor of the computing device, an optimum resistance value of the resistor across the receiver, a channel capacity and a suitable communicating device position; and
adjusting, by the processor of the computing device, a peak power transferred between the first communicating device and the second communicating device based on the determined optimum resistance value of the resistor across the receiver, the channel capacity and the suitable communicating device position.

24. The method of claim 20, further comprising:
adjusting, by the processor of the computing device, a channel bandwidth for data transfer based a body posture of the user.

25. The method of claim 20, further comprising:
determining, by the processor of the computing device, a relative orientation and a location of the first communicating device and the second communicating device and a body posture of the user;
determining, by the processor of the computing device, an extent of peak-signal transfer value at the body resonance frequency based on the determined relative orientation, location and the body posture; and
adjusting, by the processor of the computing device, the peak-signal transfer value at the body resonance frequency based on the determined extent and by determining termination and source resistance levels at the receiver and the transmitter.
